(19) United States
(12) Patent Application Publication
(10) Pub. No.: US 2011/0314303 A1
(43) Pub. Date: Dec. 22, 2011

(54) COMPUTING DEVICE CONFIGURED FOR OPERATING WITH INSTRUCTIONS IN UNIQUE CODE

(76) Inventors: Oleksiy Yu. Shevchenko, Broadlands, VA (US); Alexander V. Pyntikov, Ashburn, VA (US)

(21) Appl. No.: 12/819,568

(22) Filed: Jun. 21, 2010

(51) Int. Cl. G06F 9/30; G06F 9/455; G06F 21/22

(52) U.S. Cl. 713/190; 712/208; 718/1; 712/E09.028

(57) ABSTRACT

A computing device having a memory for holding software instructions produced in a code, which is unique for a particular computing device. A code conversion unit converts the unique code into a generic code representing the instructions. The generic code different from the unique code is common for computing devices having a processor of a similar type. A processing circuit of the computing device is linked to the output of the code conversion unit for processing instructions in the generic code.

### TECHNICAL FIELD

This disclosure relates to computer systems, and more particularly, to a computing device configured for operating with instructions produced in a code unique for a particular computing device.

### BACKGROUND ART

FIG. 1 illustrates a conventional processor or central processing unit (CPU) 10 that carries out instructions of a computer program. The CPU 10 includes a front end section 12 that interacts with external circuits, and a back end section 14 responsible for executing instructions. For example, the front end section 12 may include an input/output (I/O) unit used for exchanging information with external circuits, program counters indicating addresses of instructions being executed or to be executed, and instruction registers storing instructions being executed or decoded. The back end section 14 may include processor registers, an arithmetic logic unit (ALU) that performs arithmetic and logical operations, and a floating-point unit (FPU) that carries out operations on floating point numbers. A data bus 16 and an address bus 18 are provided to supply data and address information to and from the front end section 12. As shown in FIG. 2, the front end section 12 may fetch an instruction and decode it. The back end section 14 may execute the decoded instruction.

As illustrated in FIG. 3, the CPU 10 may use a cache memory 16 to reduce the average time to access a main memory 18. When the CPU 10 needs to read from or write to a location in the main memory 18, it first checks whether a copy of that data is in the cache 16. If so, the CPU 10 immediately reads from or writes to the cache 16, which is much faster than reading from or writing to main memory 18. The CPU 10 may use multiple levels of cache 16, with small fast caches backed up by larger slower caches. Multi-level caches generally operate by checking the smallest Level 1 (L1) cache first; if it hits, the CPU 10 proceeds at high speed. If the smaller cache L1 misses, the next larger cache L2 is checked, then the following larger cache L3 and so on, before the main memory 16 is checked.

An instruction fetch unit 20 in the front end section 12 may fetch an instruction of a computer program, i.e. retrieve it from the cache 16 or the main memory 18. The fetched instruction indicates what the CPU 10 should do. A translate/decode unit 22 translates or decodes the fetched instruction. For example, the translate/decode unit 22 may translate or decode an instruction of a computer program into a microcode that defines sequences of detailed circuit-level operations. A branch unit 24 is used to guess which sequence will be executed each time the instruction set contains a conditional jump, so that the fetch and translate/decode units can get the instructions ready in advance.

An instruction is a single operation of an instruction set. Each instruction is represented by a code including a pattern of bits that by physical design correspond to different commands to the CPU. In particular, an instruction may be produced in a generic code interpreted by the translate/decode unit 22 in a manner common for CPUs of a certain type, for example, in a way defined by an instruction set architecture (ISA) of the CPU, such as the x86 architecture. The instruction may include an operation code that specifies the operation to be performed. The ISA determines the specification and format of the operation code. In addition to the operation code, an instruction may have operand specifiers that specify operands (i.e. data) on which the operation should act. For example, the operand specifiers may specify registers, memory locations, or literal data.

The size or length of an instruction varies from as little as four bits in some microcontrollers to many hundreds of bits in very long instruction word (VLIW) architectures. Most modern processors used in personal computers, mainframes, and supercomputers have instruction sizes between 16 and 64 bits. In some architectures, such as Reduced Instruction Set Computers (RISC), instructions have a fixed length, typically corresponding to that architecture's word size. In other architectures, instructions have variable length, typically integral multiples of a byte or a halfword.

Instruction set architecture is distinguished from the microcode architecture used to implement the instruction set. Computers with different microcode architectures can share a common instruction set. For example, the Intel Pentium and the AMD Athlon implement nearly identical versions of the x86 instruction set, but have different microcode architectures.

After the fetch and translate/decode steps, the execute step is performed in the back end section 14 to execute the instruction based on the microcode. During this step, various portions of the back end section 14 are interconnected in a way required to perform desired operations.

However, instead of instructions of a valid computer program, the CPU may fetch and execute instructions of a malicious program, such as a computer virus or worm. Instructions of a malicious program may be written in a manner similar to instructions of a valid computer program. Moreover, multiple ways are developed by hackers to hack instructions written in a generic code defined by the ISA, such as x86 instructions. Hence, hackers are able to write malicious programs in the generic code corresponding to a specific type of a CPU. Conventional CPU's architectures discussed above do not have ability to distinguish instructions of a malicious program from instructions of a valid program. Therefore, a CPU will execute the malicious program in the same manner as the valid program.

Accordingly, there is a need for a computer device that would prevent a CPU from executing instructions of a malicious program.

Moreover, the physical architecture of a single CPU may be shared by multiple virtual machines (VMs), each running their own programs. The software layer providing the virtualization is called a virtual machine monitor or hypervisor. The hypervisor can run on bare hardware or on top of an operating system. Although the hypervisor may isolate programs run by one VM from programs run by another VM, all VMs in a CPU share the same instruction code defined by the ISA of that CPU. In addition, VMs share common hardware resources. Therefore, if a malicious program is injected into one VM, the injected malicious program can pass from this VM to another VM via common hardware resources. For example, an attacker that penetrates one VM may attack another VM run on the same CPU by performing code injection via a common cache memory that store instructions shared by both VMs.

Accordingly, there is a need for a computer device, in which one VM is prevented from executing instructions of another VM.

### SUMMARY OF THE DISCLOSURE

The present disclosure offers a computing device having a memory for holding software instructions produced in a code, which is unique for a particular computing device. A code conversion unit converts the unique code into a generic code representing the instructions. The generic code different from the unique code is common for computing devices having a processor of a similar type. A processing circuit of the computing device is responsive to an output of the code conversion unit for processing the instructions in the generic code.

In accordance with one aspect of the invention, the processing circuit may be configured so as to prevent the computing device from executing instructions that are not supplied from the output of the code conversion unit. Therefore, the computing device will not execute instructions in a generic code which are not converted from the unique code of that particular computing device. Hence, malicious instructions cannot be executed.

The code conversion unit may be configured to operate in an original mode, in which an input code applied to the code conversion unit is produced at the output of the code conversion unit, and to operate in a conversion mode, in which the unique code is converted into the generic code.

A key unit may hold a unique cryptographic key corresponding to the unique code. The unique cryptographic key may be provided to the code conversion unit to set the code conversion unit to operate in the conversion mode so as to convert the unique code into the generic code.

In accordance with one embodiment of the invention, the instructions in the unique code may be provided from a source outside of the computing device. The unique code may be produced in accordance with an external unique key that may define the unique cryptographic key held in the computing device.

The code conversion unit may be configured to operate in the conversion mode in accordance with the external unique cryptographic key. For example, when the instructions in the unique code are activated, the code conversion unit is automatically configured to operate in the conversion mode

Alternatively, the unique cryptographic key may be generated in the computing device and may be transmitted to the source outside of the computing device for producing the unique code in accordance with the unique cryptographic key.

In accordance with another exemplary embodiment, the instructions in the unique code may be produced inside the computing device based on external instructions in a code different from the unique code. For example, the external instructions may be in the generic code, and the unique code may be converted from the generic code in accordance with the unique cryptographic key.

In one example, the processing circuit may be configured as a multi-core processor having first and second processing circuits. The memory may hold first and second codes unique for the first and second processing circuits, respectively. The first unique code differs from the second unique code. The code conversion unit may convert the first unique code into the generic code supplied to the first processing circuit, and convert the second unique code into the generic code supplied to the second processing circuit.

In accordance with another aspect of the disclosure, a computing device has a processing circuit for running at least first and second virtual machines. The processing circuit is configured for processing instructions in a generic code common for computing devices of a similar type. A memory may hold software instructions produced at least in first and second unique codes different from the generic code. The first unique code is unique for the first virtual machine, the second unique code different from the first unique code is unique for the second virtual machine. A code conversion unit converts the first unique code into the generic code supplied to the processing circuit for execution by the first virtual machine, and converts the second unique code into the generic code supplied to the processing circuit for execution by the second virtual machine.

The code conversion unit may comprise a first code conversion module for converting the first unique code into the generic code, and a second code conversion module for converting the second unique code into the generic code.

The processing circuit may be configured so as to prevent the first virtual machine from executing instructions that are not supplied from an output of the first code conversion module, and to prevent the second virtual machine from executing instructions that are not supplied from an output of the second code conversion module. Hence, one virtual machine is prevented from execution instructions of another virtual machine.

The first code conversion module may be configured to operate in an original mode, in which an input code applied to the first code conversion module is produced at an output of the first code conversion module, and to operate in a conversion mode, in which the first unique code is converted into the generic code. Similarly, the second code conversion module may be configured to operate in the original mode, in which the input code applied to the second code conversion module is produced at an output of the second code conversion module, and to operate in a conversion mode, in which the second unique code is converted into the generic code.

A key unit may hold first and second unique cryptographic keys respectively corresponding to the first and second unique codes. The first unique cryptographic key may be provided to the first code conversion module to configure the first code conversion module to operate in the conversion mode so as to convert the first unique code into the generic code. The second unique cryptographic key may be provided to the second code conversion module to configure the second code conversion module to operate in the conversion mode so as to convert the second unique code into the generic code

Also, the processing circuit may run a hypervisor for controlling operation of the first and second virtual machines. The memory may hold software instructions produced in a third unique code unique for the hypervisor and different from the first and second unique codes and from the generic code. The code conversion unit may comprise a third code conversion module for converting the third unique code into the generic code supplied to the processing circuit for execution by the hypervisor.

The third code conversion module may be configured to operate in an original mode, in which an input code applied to the first code conversion module is produced at an output of the first code conversion module, and to operate in a conversion mode, in which the third unique code is converted into the generic code. The key unit may hold a third unique cryptographic key corresponding to the third unique code. The third unique cryptographic key may be provided to the third code conversion module to configure the third code conversion module to operate in the conversion mode so as to convert the third unique code into the generic code. The processing circuit may be configured so as to prevent the hypervisor from executing instructions that are not supplied from an output of the third code conversion module.

In accordance with a further aspect of the disclosure, the code conversion unit may support operation of the second virtual machine in a non-secure mode, in which the first code conversion module converts the first unique code into the generic code executed by the first virtual machine, and the second code conversion module allows the second virtual machine to execute the generic code supplied to an input of the second conversion module.

In accordance with a method of the present disclosure, the following steps are carried out for operating a computing device:
producing software instructions in a unique code which is unique for the computing device,
storing the instructions in the unique code in a memory of the computing device,
converting the unique code by a code conversion unit into a generic code different from the unique code and common for computing devices of a particular type, and
executing by a processor, the generic code converted from the unique code.

The instructions in the unique code may be produced outside of the computing device. For example, the instructions may be converted from the generic code using a unique cryptographic key generated in the computing device.

Alternatively, the instructions in the unique code may be produced in the computing device by converting the instructions from the generic code using a unique cryptographic key.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The drawing figures depict concepts by way of example, not by way of limitations. In the figures, like reference numerals refer to the same or similar elements.

FIGS. 1-3 are diagrams illustrating operations performed by a conventional CPU.

FIG. 4 schematically illustrates an exemplary embodiment of a computing device of the present disclosure.

FIG. 5 schematically illustrates another exemplary embodiment of a computing device of the present disclosure.

FIG. 6 schematically illustrates operation of a computing device of the present disclosure when software instructions in a unique code are produced outside of the computing device.

FIGS. 7 and 8 schematically illustrate operation of a computing device of the present disclosure when software instructions in a unique code are produced in the computing device.

### DETAILED DISCLOSURE OF THE EMBODIMENTS

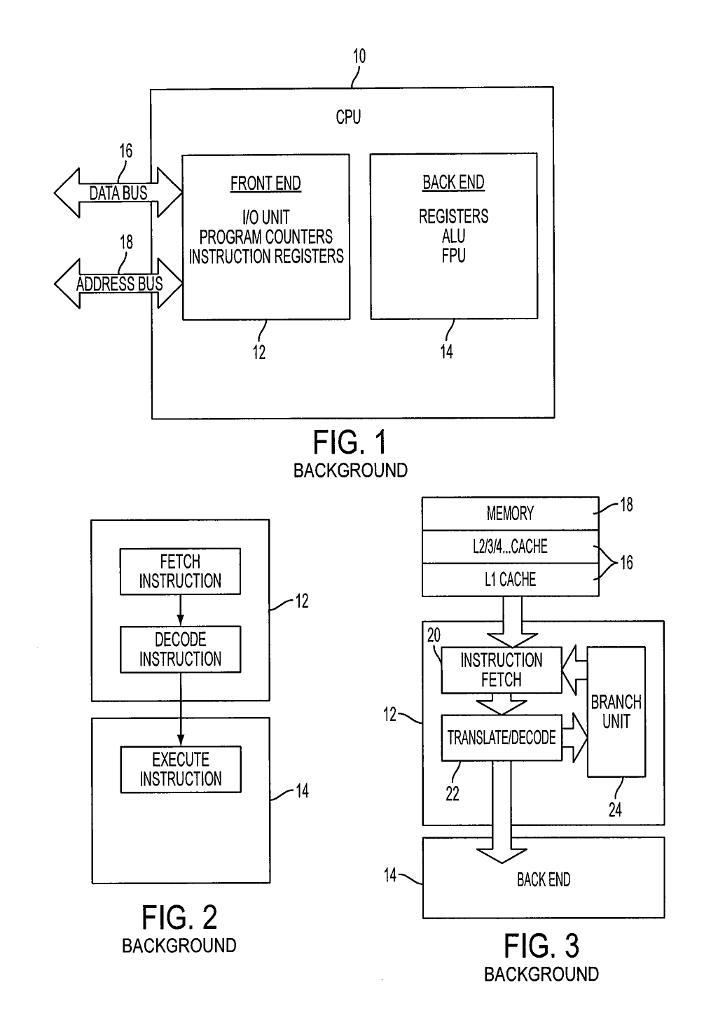

The present disclosure will be made with an example of a computing device configured in a manner illustrated in FIGS. 1-3. It will become apparent, however, that the concepts described herein are applicable for any device having circuitry for executing software instructions. For example, the computing device of the present disclosure may be a mobile telephone communication device or a power meter in a grid computing system.

In accordance with the present disclosure, a computing device is configured in a manner that enables the computing device to operate only with instructions that are unique for that computing device, and prevents the computing device from operating with instructions in a generic code common for computing devices of a particular type, e.g. with an instruction set in a generic code common for computing devices having the same instruction set architecture (ISA). As an attacker cannot obtain instructions that are unique for each computing device, he is not able to generate a malicious code that would imitate these unique instructions and could be injected into a particular computing device. Moreover, even if an attacker breaks the unique instruction code by gaining physical access to a particular computing device, he still is not able to penetrate other computing device of the same type because codes of their instructions differ from the broken instruction code.

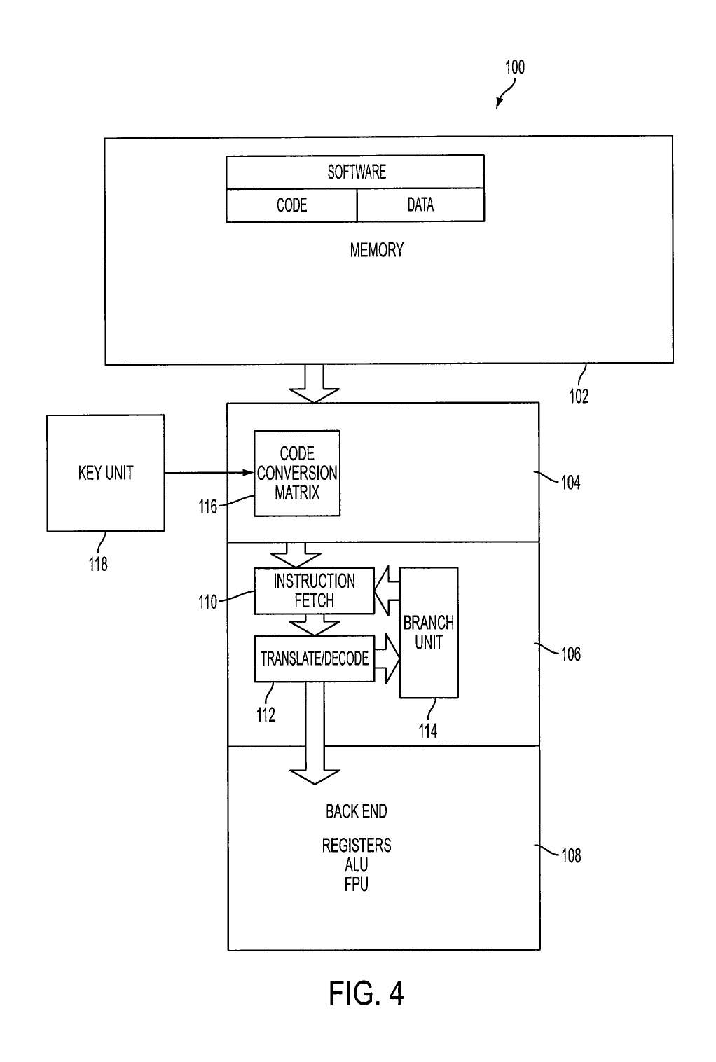

Referring to FIG. 4 that schematically shows an exemplary embodiment that illustrates a concept of the present disclosure, a computing device 100 of the present disclosure may include a memory section 102, a conversion matrix section 104, and a CPU including a front end section 106 and a back end section 108.

The memory section 102 in FIG. 4 may include any internal or external information storage that can be used by the computing device 100, such as a cache memory, hard drive memory, flash memory, random access memory, read only memory, etc. The memory section 102 may store any software used by the computing device 100 such as an operating system, application software, firmware, utilities, middleware, etc. The software includes a code of instructions that can be executed by the computing device 100, and data for use by the computing device 100 when instructions are executed. As discussed in more detail below, a code of instructions held in the memory section 102 is unique for the computing device 100 and different from an instruction code common for computing devices similar to the computing device 100.

The front end section 106 includes an instruction fetch unit 110 for fetching instructions to be executed, a translate/decode unit 112 for translating or decoding fetched instructions, and a branch unit 114 that predicts which sequence will be executed each time the instruction set contains a conditional jump, so that the fetch and translate/decode units can get the instructions ready in advance. The back end section 108 may contain registers, ALU and FPU used for executing instructions.

In accordance with the present disclosure, a code of instructions stored in the memory section 102 is a code unique for a particular computing device 100. This unique code differs from a generic code of instructions common for computing devices of a similar type. For example, the generic code may be defined by the instruction set architecture (ISA) used by the CPU of the computing device 100. The generic code may be common for computing devices having the same ISA as the computing device 100. While computing devices of a similar type, such as computing devices having the same ISA, may share the same generic code, they operate with different unique codes. An example of the generic code is the x86 code corresponding to instructions defined by the x86 instruction set architecture.

The conversion matrix section 104 includes a code conversion matrix 116 that converts the unique code of an instruction to be executed by the CPU into the generic code representing that instruction. The unique code is supplied to the input of the code conversion matrix 116 from the memory section 102. The generic code produced at the output of the code conversion matrix 116 is supplied to the instruction fetch 110. The generic code may be defined by the ISA of the CPU so as to enable the front end section 106 of the CPU to translate and decode the generic code and to enable the back end section 108 of the CPU to execute fetched instructions. The code conversion matrix 116 may be implemented as an assembler program run by the CPU to translate the unique code of the computing device 100 into the generic code common for all CPUs having the ISA of the CPU used in the computing device 100. Alternatively, code conversion circuitry including logic circuits and registers configured for converting the unique code into the generic code may be provided on the CPU chip or externally with respect to the CPU.

To enable a computer manufacturer to install the same code conversion matrix 116 in any computing device of a similar type, the code conversion matrix 116 may be originally configured to operate in a “transparent” mode so as to develop at the output of the matrix 166 the same code as a code applied to its input. A key unit 118 may be provided to reconfigure the code conversion matrix 116 to perform code conversion unique for a particular computing device. In particular, the key unit 118 may store a cryptographic key unique to the computing device 100 and selected to enable the code conversion matrix 116 to convert the code unique for the computing device 100 into the generic code. For example, as discussed in more detail below, the unique key of the computing device 100 may be a key used for coding instructions into the unique code of the computing device 100. The unique key is supplied to the code conversion matrix 116 to adjust the matrix so as to provide code conversion from a unique code into a generic code in accordance with the unique key.

After the code conversion matrix 116 is adjusted using the unique key, the matrix 116 becomes configured to produce the generic code at its output only if the unique code stored in the memory section 102 is supplied to its input. When the CPU of the computing device 100 accesses a memory section 102, e.g. a cache memory, to obtain an instruction of any program to be executed, the code of that instruction is supplied to the input of the code conversion matrix 116. When the instruction is represented by the unique code, the code conversion matrix 116 converts the unique code of the instruction into the generic code representing that instruction. The instruction in the generic code, such as an x86 instruction, is supplied to the front end section 106 of the CPU for execution by the back end section 107.

For example, if the MOVE instruction in a generic instruction set common for CPUs of a certain type is represented by code 0101, this instruction coded in a manner unique for a particular CPU may be represented by code 0011. The code conversion matrix 116 translates the unique code 0011 into the generic code 0101 to enable the CPU to recognize the MOVE instruction. Considering that most modern processors used in personal computers, mainframes, and supercomputers have instruction sizes between 16 and 64 bits, it is possible to generate codes unique for each of millions of CPUs. In particular, the unique code of an instruction set may be formulated so as to produce the no operation (NOP) instruction at the output of the code conversion matrix 116 when a generic code of most common instructions is supplied at its input.

If an instruction represented by a code different from the unique code, such as an instruction of a malicious code imitating the generic code, is applied to the input of the code conversion matrix 116, that instruction would not be produced at the output of the matrix 116 in the generic code defined by the ISA of the CPU. Instead, the NOP instruction or some unrecognizable instruction is produced. As a result, the CPU would not respond to the instruction. Hence, the CPU of the computing device 100 would not execute a malicious code even if this code is injected by an attacker into the computing device 100.

For example, an attacker may use a malicious script at a website visited by a browser of the computing device 100 to perform code injection using the holes of the browser. As a result, a malicious program, such as a computer virus, worm or Trojan horse, may be sent to the computing device 100 for execution. However, the attacker does not know the unique code used by the computing device 100. Therefore, the malicious program cannot be coded in the unique code. Instead, malicious programs are usually formulated in a generic code common for a certain type of CPUs. However, the CPU of the computing device 100 would not execute any program written in a code different from the unique code of the computing device 100. Therefore, the malicious code injected into the computing device 100 would not be executed. Even if the attacker determines the unique code of a single computing device, for example, by obtaining physical access to that computer, he still is not able to penetrate other computing device of the same type because they have different unique codes.

Moreover, the instruction fetch unit 110 of the CPU is linked to the output of the code conversion matrix 116 so as to receive only instructions supplied from the output of the code conversion matrix 116. This configuration prevents the computing device 100 from executing any instruction that are not supplied from the output of the code conversion matrix 116. Therefore, although the CPU executes instructions in a generic code, it is prevented from executing a generic code of any instruction which is not converted from the unique code of the computing device 100.

It is noted that the CPU may be manufactured so as to enable the front end section 106 and the back end section 108 to interpret and execute the unique code. However, in this case, each CPU must be manufactured individually in accordance with unique manufacturing rules. The code conversion matrix 116 that converts the unique code into the generic code enables a computer manufacturer to manufacture CPUs configured for executing a common instruction set defined for that type of CPUs. Therefore, manufacturing cost of computing devices operating with unique codes is minimized.

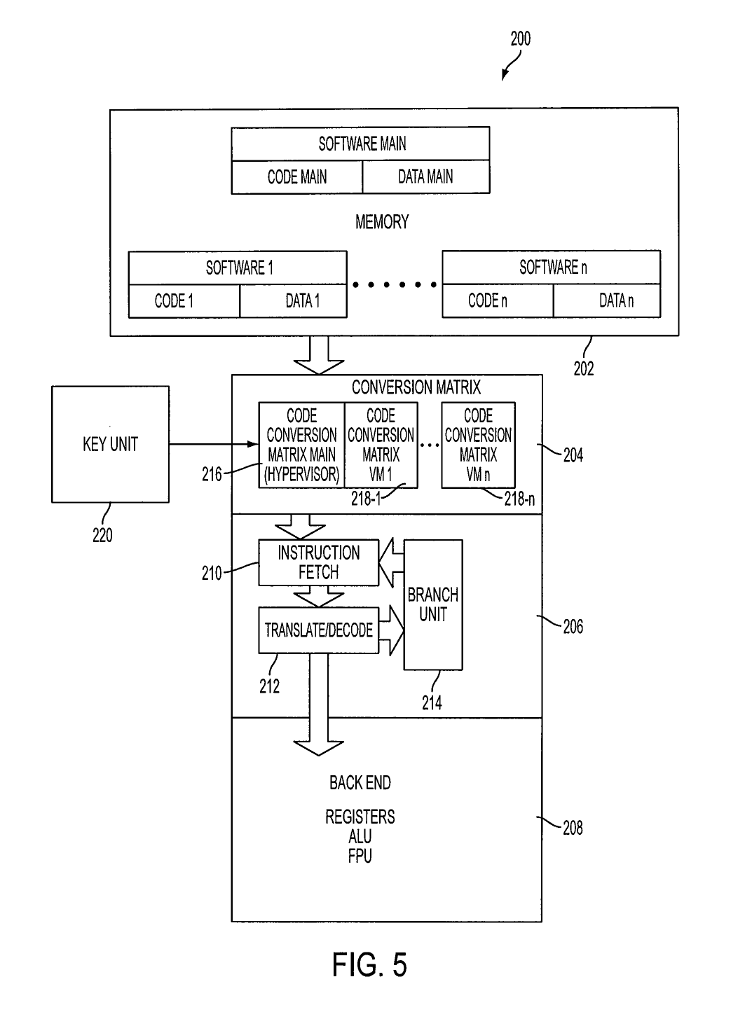

Referring to FIG. 5 that illustrates another exemplary embodiment of the present disclosure, a computing device 200 may comprise a memory section 202, a conversion matrix section 204, and a CPU including a front end section 206 and a back end section 208. Similarly to the memory section in FIG. 4, the memory section 202 may include any internal or external information storage that can be used by the computing device 200, such as a cache memory, hard drive memory, flash memory, random access memory, read only memory, etc. The front end section 206 and the back end section 208 may operate in a manner similar to the respective sections in FIG. 4. The front end section 206 includes an instruction fetch unit 210 for fetching instructions to be executed, a translate/decode unit 212 for translating or decoding fetched instructions, and a branch unit 214 that predicts which sequence will be executed each time the instruction set contains a conditional jump, so that the fetch and translate/decode units can get the instructions ready in advance. The back end section 208 may contain registers, ALU and FPU used for executing instructions.

The computing device 200 is configured for running multiple virtual machines VM1 to VMₙ using common physical resources such as a CPU, memory section, peripheral devices, etc. Each virtual machine VM is a software implementation of a physical computer that executes programs like a physical machine. The virtual machines VM1 to VMₙ may be system virtual machines providing complete system platforms to supports the execution of separate operating systems. Alternatively, the virtual machines VM1 to VMₙ may include a process virtual machine designed to run a single program.

To allow sharing of the underlying physical resources between different virtual machines VM1 to VMₙ, the software layer called a virtual machine monitor or hypervisor is provided. An example of a hypervisor is Microsoft Hyper-V which is a part of the Windows Server 2008 product. A hypervisor may run directly on the host's hardware to control the hardware and to monitor operating systems of different virtual machines. The operating systems of the virtual machines may run at a software level above the hypervisor.

The memory section 202 contains software for the hypervisor and each of the virtual machines VM1 to VMₙ. This software may include any software used by the hypervisor and each of the virtual machines VM1 to VMₙ, such as operating systems, application software, firmware, utilities, middleware, etc. The software (SOFTWARE MAIN) for the hypervisor includes code of instructions (CODE MAIN) that can be executed by the hypervisor, and data (DATA MAIN) for use by the hypervisor when instructions are executed. The software (SOFTWARE1 to SOFTWAREₙ) for each of the virtual machines VM1 to VMₙ includes code of instructions (CODE1 to CODEₙ) that can be executed by the respective virtual machine VM1 to VMₙ, and data (DATA1 to DATAₙ) for use by the respective virtual machine VM1 to VMₙ when instructions are executed.

The code CODE MAIN is a code unique for the hypervisor. The codes CODE1 to CODEₙ are unique for respective virtual machines VM1 to VMₙ. The unique hypervisor's code differs from the unique codes of the virtual machines VM1 to VMₙ. The unique code of each VM differs from the unique code of any other VM run on the same computing device 200. The unique codes of hypervisor and VMs may differ from a generic code of instructions executable by the CPU that may be defined by the instruction set architecture (ISA) used by the CPU. For example, the generic code may correspond to the X86 code defined by the x86 instruction set architecture.

The conversion matrix section 204 includes a code conversion matrix 216 that converts the unique code of hypervisor's instructions into the generic code, and code conversion matrixes 218-1 to 218-n that respectively convert the unique codes of virtual machines VM1 to VMₙ into the generic code. A key unit 220 is provided to store a unique cryptographic key for the hypervisor, and unique cryptographic keys for each of the virtual machines VM1 to VMₙ. The code conversion matrix 216 and 218-1 to 218-n may be originally configured to operate in a “transparent” mode to produce at their outputs codes applied to their inputs. The unique key for the hypervisor is selected to reconfigure the code conversion matrix 216 so as to convert the unique code of the hypervisor into the generic code. The unique keys for virtual machines VM1 to VMₙ are selected to respectively reconfigure the code conversion matrixes 218-1 to 218ₙ so as to respectively convert the unique codes CODE1 to CODEₙ into the generic code. For example, the unique keys may be keys used for coding instructions into respective unique codes.

When the CPU runs the hypervisor, the CPU accesses the memory section 202 to supply the unique code CODE MAIN to the input of the code conversion matrix 216. The generic code produced at the output of the code conversion matrix 216 via the instruction fetch 210 is supplied for execution by the CPU. The generic code may be defined by the ISA of the CPU so as to enable the front end section 206 of the CPU to translate and decode the generic code and to enable the back end section 208 of the CPU to execute the generic code. When the CPU runs the respective virtual machine VM₁ to VMₙ, the respective unique code CODE1 to CODEₙ is accessed by the CPU and supplied to the respective code conversion matrix 218-1 to the 218-n for producing the generic code executed by the CPU.

The instruction fetch unit 210 is linked to the outputs of the code conversion matrixes 216 and 218-1 to 218-n so as to receive only instructions from the output of the code conversion matrix 216 when the hypervisor is run, and to receive only instructions from the output of the code conversion matrix 218-i when the respective VMᵢ is run. Hence, the hypervisor is prevented from executing instructions of any of VMs, and each of VMs is prevented from executing instructions of another VM or the hypervisor. As a result, each VM run in the computing device 200 is completely isolated from another VM or hypervisor.

In a conventional computing device that runs multiple VMs, if a malicious program is injected into one VM, the injected malicious program can pass from this VM to another VM via common hardware resources. For example, an attacker that penetrates one VM may attack another VM run on the same CPU by performing code injection via a common cache memory that store instructions shared by both VMs.

In the computing device 200 of the present disclosure, even if an attacker performs malicious code injection into one VM, he is not able to penetrate the other VMs via common hardware resources because each VM in the computing device 200 would not execute instructions of the other VM.

To improve usability of the computing device of the present disclosure, one of code conversion matrixes 218-1 to 218-n can be left in a “transparent” mode to produce at its output a code supplied to its input. When a user of the computing device 200 needs to run a program but does not have a unique code for this program, a “blank” VM corresponding to the “transparent” code conversion matrix 218 may be launched to run this program. As a result, the program in a generic code may be executed by the CPU. For example, a browser may be run in the “blank” VM to access “unsafe” websites. Even if an attacker uses a malicious script on a website visited by the browser to inject malicious code into the “blank” VM, the attacker is not able to attack other VMs via the compromised VM.

Hence, multiple VMs in the computing device 200 may be used to operate with data from sources having different levels of trust. For example, one VM may be used for accessing a corporate intranet, while the other VM may be used for operating with less trusted computer resources. The unique code of VM operating with a corporate intranet would prevent an attacker from penetrating the corporate intranet via the other VM.

Also, multiple VMs may be used to operate in environments required different security levels. For example, one VM may be used for performing financial transactions, while the other VM may be used for entertainment. The unique code of the VM operating with financial resources would prevent an attacker from accessing sensitive information of the user, such an banking account or credit card information.

As one skilled in the art would realize, the concept of the present disclosure discussed in connection with FIGS. 4 and 5 is also applicable to a multi-core processor composed of two or more independent cores. Multiple cores of a multi-core processor may be associated with respective code conversion matrixes to operate with different unique codes in a manner similar to operations of different VMs discussed in connection with FIG. 5. For example, the memory section 202 may hold codes unique for the respective cores. The code conversion matrixes 218 may convert the respective unique codes into the generic code supplied to the respective cores. In this case, even if an attacker injects a malicious code in one of the cores, he would not be able to penetrate another core of the same processor via resources shared by the cores.

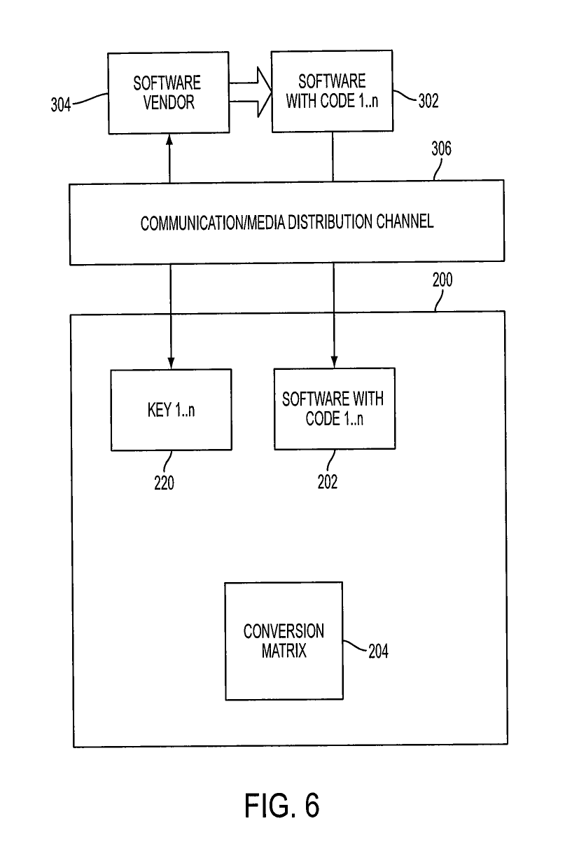

As shown in FIG. 6 that illustrates an example of unique code delivery to the computing device 200, instructions of software 302 may be encoded in one or more unique codes CODE1 to CODEₙ by a software vendor 304 that produces the respective software. Via a communication/media distribution channel 306, the software 302 with instructions in one or more unique codes CODE1 to CODEₙ is delivered to the computing device 200 and loaded into the memory section 202. As one skilled in the art would realize, the unique codes CODE1 to CODEₙ may be any codes unique for a computing device 200, including codes unique for particular virtual machines and a hypervisor employed in the computing device 200, or codes unique for particular cores of a multi-core processor in the computing device 200. For example, the software 302 with instructions in one or more unique codes may be pre-installed in the computing device 200, downloaded from the Internet or delivered on a storage medium such as CD or DVD by mail.

In addition to encoding instructions of the software 302 into a unique code, the software vendor 304 may create a unique key associated with that code. For example, the unique key may be a cryptographic key used for coding instructions of the software 302 in the respective unique code. The unique key Key1 to Keyₙ associated with the respective unique code CODE1 to CODEₙ may be delivered to the computing device 200 via the communication/media distribution channel 306 and loaded into the key unit 220. The unique key may be used for reconfiguring the respective code conversion matrix in the conversion matrix section 204 so as to enable the matrix to convert the unique code into the generic code.

For example, the code conversion matrix may be automatically reconfigured when the software 302 is activated by the software vendor 304 over the Internet or over the telephone. The software vendor 304 may access the unique key delivered to the computing device 200 and perform reconfiguration of the respective code conversion matrix in accordance with the key.

In an alternative example, when a customer wants to purchase software 302 from the software vendor 304, one or more unique cryptographic keys Key1 to Keyₙ may be manually or automatically generated in the computing device 200 of the customer. The generated unique keys Key1 to Keyₙ may be transferred to the software vendor 304 that encodes instructions of the software 302 into one or more unique codes CODE1 to CODEₙ using the respective keys Key1 to Keyₙ. Thereafter, the software 302 with instructions in one or more unique codes CODE1 to CODEₙ is delivered to the computing device 200 via the communication/media distribution channel 306. During activation of the software 302, the respective key is used for reconfiguring the respective code conversion matrix in the conversion matrix section 204 to enable the matrix to convert the unique code into the generic code. This approach creates additional layers of protection for a user of a computing device by ensuring that the unique code produced by the software vendor can operate only on the customer's computing device, and by preventing a false key from being loaded into the computing device.

To protect the customer from transferring the key to a hacker that imitates a valid software vendor, the key unit 220 may include a trusted key store containing trusted certificates of valid software vendors. If the customer initiates transferring the key to a vendor who is not listed in the trusted key store, the key unit 220 may compare the vendor's certificate with the stored trusted certificates and may prevent the key from being sent to the vendor who does not have a trusted certificate listed in the trusted key store.

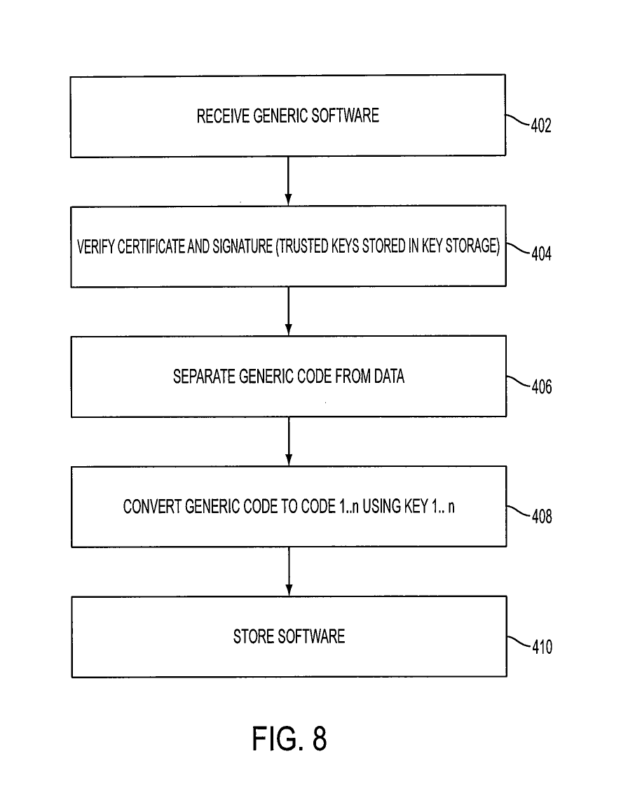

FIGS. 8 and 9 illustrate another example of producing unique codes in accordance with the present disclosure. As shown in FIG. 8, a software vendor 304 delivers to the computing device 200 via the communication/media distribution channel 306 software 308 including instructions and respective data. The instructions may be in a generic code common for computers of a certain type, for example, in the x86 code. As instructions of the software 308 are not in the unique code of the computing device 200, the CPU of computing device 200 cannot execute these instructions. Instead the software 308 with instructions in the generic code is loaded into the memory section 202 of the computing device 200 (step 402 in FIG. 8).

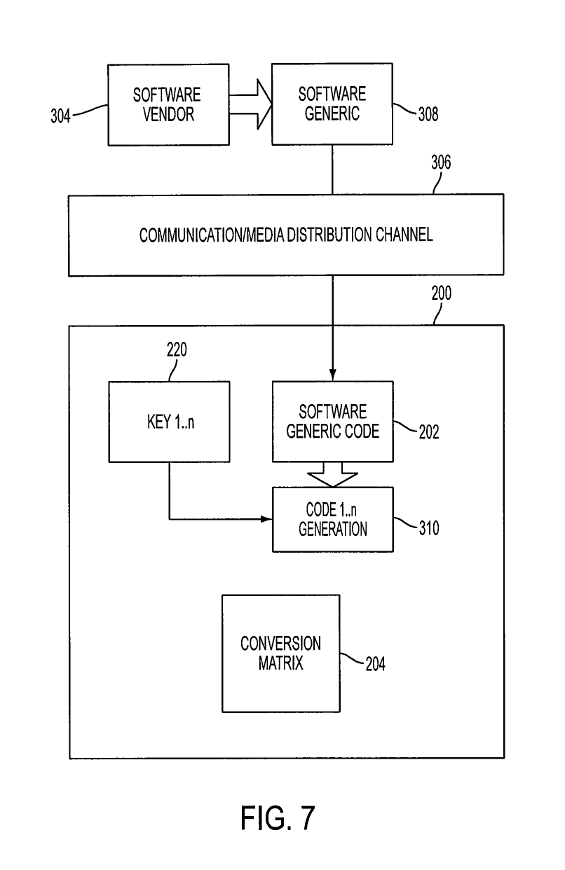

Thereafter, the computing device 200 performs validation of the software 308, for example, by verifying the software vendor's certificate and software signature (step 404). The trusted keys stored in the key unit 220 may be used for validation. Then, instructions of the software 308 encoded in the generic code are separated from data (step 406). A unique code generation unit 310 (FIG. 7) may be provided for converting the generic code into one or more unique code CODE1 to CODEₙ using the respective unique cryptographic keys Key1 to Keyₙ stored in the key unit 220 (step 408). The unique keys may be manually or automatically generated in the computing device 200. Instructions in one or more unique codes CODE1 to CODEₙ generated by the unique code generation unit 310 may be stored in the memory section 202 together with respective data (step 410). As discussed above in connection with FIGS. 4 and 5, when the computing device 202 needs to run the software, instructions in the unique code are supplied to the respective code conversion matrix for converting into the generic code. For example, the unique code inside the computing device 200 may be generated when trusted freeware is downloaded from the Internet. As one skilled in the art would realize, the code of software instructions provided to the computing device does not necessarily coincide with the generic code at the output of the code conversion matrix.

Also, as discussed above in connection with FIG. 5, to improve usability of the computing device 200, one of the code conversion matrix 218 may operate in a “transparent” mode so as to convert a generic code at its input into the same generic code at its output. The computing device 200 may operate in a non-secure mode of operation so as to run the virtual machine associated with the “transparent” code conversion matrix. For example, the non-secure mode of operation may be used to provide compatibility of the computing device 200 with software having instructions in the generic code. If a malicious code is accidentally injected into the virtual machine while the computing device 200 operates in the non-secure mode, the attacker would not be able to penetrate another virtual machine on the same CPU, for example, via shared hardware resources, such as a cache memory, because the other virtual machine is able to execute only the unique code associated with that machine and cannot execute the malicious code, which is generic. Therefore, transactions performed using the other virtual machine will not be compromised. The non-secure mode of operation may be used to enable the computing device 200 to download any software with instructions in the generic code, even non-trusted software supplied without the signature.

The embodiments described hereinabove are further intended to explain best modes known of practicing the invention and to enable others skilled in the art to utilize the invention in such, or other, embodiments and with the various modifications required by the particular applications or uses of the invention. For example, in network environments, the unique code discussed above may be unique not for an individual computer, but for a group of computers arranged in a network.

Accordingly, the description is not intended to limit the invention to the form disclosed herein. Also, it is intended that the appended claims be construed to include alternative embodiments.

What is claimed is:

1. A computing device comprising:
a memory for holding software instructions produced in a unique code, which is unique for a particular computing device,
a code conversion unit for converting the unique code into a generic code representing the instructions, the generic code being different from the unique code and common for computing devices having a processor of a similar type, and
a processing circuit responsive to an output of the code conversion unit for processing the instructions in the generic code.

2. The computing device of claim 1, wherein the code conversion unit is configured to operate in an original mode, in which an input code applied to the code conversion unit is produced at the output of the code conversion unit, and to operate in a conversion mode, in which the unique code is converted into the generic code.

3. The computing device of claim 2 further comprising a key unit for holding a unique cryptographic key corresponding to the unique code, the unique cryptographic key being provided to the code conversion unit to configure the code conversion unit to operate in the conversion mode so as to convert the unique code into the generic code.

4. The computing device of claim 1, wherein the processing circuit is configured so as to prevent the computing device from executing instructions that are not supplied from the output of the code conversion unit.

5. The computing device of claim 3, wherein the instructions in the unique code are provided from a source outside of the computing device.

6. The computing device of claim 5, wherein the unique cryptographic key is defined by an external unique key provided outside of the computing device.

7. The computing device of claim 6, wherein the unique code is produced in accordance with the external unique key.

8. The computing device of claim 7, wherein the code conversion unit is configured to operate in the conversion mode in accordance with the external unique cryptographic key.

9. The computing device of claim 5, wherein the code conversion unit is automatically configured to operate in the conversion mode when the instructions in the unique code are activated.

10. The computing device of claim 5, wherein the unique cryptographic key is generated in the computing device.

11. The computing device of claim 10, wherein the unique code is produced outside of the computing device in accordance with the unique cryptographic key generated in the computing device.

12. The computing device of claim 3, wherein the instructions in the unique code are produced inside the computing device based on external instructions in a code different from the unique code.

13. The computing device of claim 12, wherein the external instructions are in the generic code, and the unique code is converted from the generic code in accordance with the unique cryptographic key.

14. The computing device of claim 1, wherein:
the processing circuit is configured as a multi-core processor having first and second processing circuits,
the memory is configured for holding first and second codes unique for the first and second processing circuits, respectively, the first unique code differs from the second unique code, and
the code conversion unit is configured for converting the first unique code into the generic code supplied to the first processing circuit, and for converting the second unique code into the generic code supplied to the second processing circuit.

15. A computing device comprising:
a processing circuit for running at least first and second virtual machines and configured for processing instructions in a generic code common for computing devices of a similar type,
a memory for holding software instructions produced at least in first and second unique codes different from the generic code, the first unique code being unique for the first virtual machine, the second unique code different from the first unique code being unique for the second virtual machine, and
a code conversion unit configured for converting the first unique code into the generic code supplied to the processing circuit for execution by the first virtual machine, and for converting the second unique code into the generic code supplied to the processing circuit for execution by the second virtual machine.

16. The computing device of claim 15, wherein the code conversion unit comprises a first code conversion module for converting the first unique code into the generic code, and a second code conversion module for converting the second unique code into the generic code.

17. The computing device of claim 15, wherein:
the first code conversion module is configured to operate in an original mode, in which an input code applied to the first code conversion module is produced at an output of the first code conversion module, and to operate in a conversion mode, in which the first unique code is converted into the generic code, and
the second code conversion module is configured to operate in the original mode, in which the input code applied to the second code conversion module is produced at an output of the second code conversion module, and to operate in a conversion mode, in which the second unique code is converted into the generic code.

18. The computing device of claim 17 further comprising a key unit for holding first and second unique cryptographic keys respectively corresponding to the first and second unique codes,
the first unique cryptographic key being provided to the first code conversion module to configure the first code conversion module to operate in the conversion mode so as to convert the first unique code into the generic code, and
the second unique cryptographic key being provided to the second code conversion module to configure the second code conversion module to operate in the conversion mode so as to convert the second unique code into the generic code

19. The computing device of claim 15, wherein the processing circuit is configured so as to prevent the first virtual machine from executing instructions that are not supplied from the first code conversion module, and to prevent the second virtual machine from executing instructions that are not supplied from the second code conversion module.

20. The computing device of claim 16, wherein:
the processing circuit is configured for running a hypervisor for controlling operation of the first and second virtual machines,
the memory is configured for holding software instructions produced in a third unique code unique for the hypervisor and different from the first and second unique codes and from the generic code, and
the code conversion unit comprises a third code conversion module for converting the third unique code into the generic code supplied to the processing circuit for executing by the hypervisor.

21. The computing device of claim 20, wherein:
the third code conversion module is configured to operate in an original mode, in which an input code applied to the first code conversion module is produced at an output of the first code conversion module, and to operate in a conversion mode, in which the third unique code is converted into the generic code, and
the key unit holds a third unique cryptographic key corresponding to the third unique code, the third unique cryptographic key being provided to the third code conversion module to configure the third code conversion module to operate in the conversion mode so as to convert the third unique code into the generic code.

22. The computing device of claim 21, wherein the processing circuit is configured so as to prevent the hypervisor from executing instructions that are not supplied from the third code conversion module.

23. The computing device of claim 16, wherein the code conversion unit is configured to support operation of the second virtual machine in a non-secure mode, in which the first code conversion module converts the first unique code into the generic code, and the second code conversion module allows the second virtual machine to execute the generic code supplied to an input of the second conversion module.

24. A method of operating a computing device comprising the steps of:
producing software instructions in a unique code which is unique for the computing device,
storing the instructions in the unique code in a memory of the computing device,
converting the unique code by a code conversion unit into a generic code different from the unique code and common for computing devices of a particular type, and
executing by a processor, the generic code converted from the unique code.

25. The method of claim 24, wherein the instructions in the unique code are produced outside of the computing device.

26. The method of claim 25, wherein the instructions in the unique code are produced outside of the computing device by converting the instructions from the generic code using a unique cryptographic key.

27. The method of claim 26, wherein the unique cryptographic key is generated in the computing device.

28. The method of claim 24, wherein the instructions in the unique code are produced in the computing device by converting the instructions from the generic code using a unique cryptographic key.
